(19) United States
(12) Patent Application Publication
(10) Pub. No.: US 2010/0012437 A1
(43) Pub. Date: Jan. 21, 2010

(54) Aerodynamic Controls for High Speed Elevators

(76) Inventor: Rory S. Smith, El Cajon, CA (US)

Correspondence Address: FROST BROWN TODD, LLC, 2200 PNC CENTER, 201 E. FIFTH STREET, CINCINNATI, OH, 45202, US

(21) Appl. No.: 12/173,386

(22) Filed: Jul. 15, 2008

(51) Int. Cl. B66B 11/02

(52) U.S. Cl. 187/401

(57) ABSTRACT

An elevator car is provided with at least one moveable aerodynamic control surface which is moveable to generate counter forces to aerodynamic forces resulting from airflow around the elevator car. Aerodynamically suitable surfaces may also be provided on either end of the elevator car.

### BACKGROUND OF THE INVENTION

Elevator cars are frequently employed to transport loads and/or persons within a short time. As the speed of the elevator car increases, ride quality decreases. One source of the degradation of ride quality is mechanical vibration resulting from the interaction between elevator guiding members and elevator guide rails. As the speed of the elevator car increases, these vibrations are excited, in part, by imperfections in the guide rails. To reduce these vibrations, several solutions have been offered. Active suspension systems, such as those described in U.S. Pat. No. 5,439,075 and U.S. Pat. No. 6,474,449, offer one solution, both of which are incorporated herein by reference. Non-contact systems involving magnets, such as those described in U.S. Pat. No. 5,321,217 and U.S. Pat. No. 5,379,864, offer another solution. Moving mass damping systems, such as those described in U.S. Pat. No. 5,811,743, offer yet another solution.

Another source of the degradation of ride quality is aerodynamic influence resulting from airflow around the elevator car. As the speed of the elevator car increases, these aerodynamic influences cause vibration, buffeting, and acoustic noise. To reduce these aerodynamic influences, shrouding measures, such as those described in U.S. Pat. Nos. 5,080,201, 5,220,979 and 6,318,509, have been offered.

The prior art fails to teach or suggest an elevator car, with improved ride quality characteristics at high speeds, of the present invention.

### BRIEF DESCRIPTION OF THE DRAWINGS

While the specification concludes with claims which particularly point out and distinctly claim the invention, it is believed the present invention will be better understood from the following accompanying drawings, in which like reference numerals identify the same elements and which:

FIG. 1 is a diagrammatic perspective view of an elevator car constructed in accordance with the teachings of the present invention.

### DETAILED DESCRIPTION OF THE INVENTION

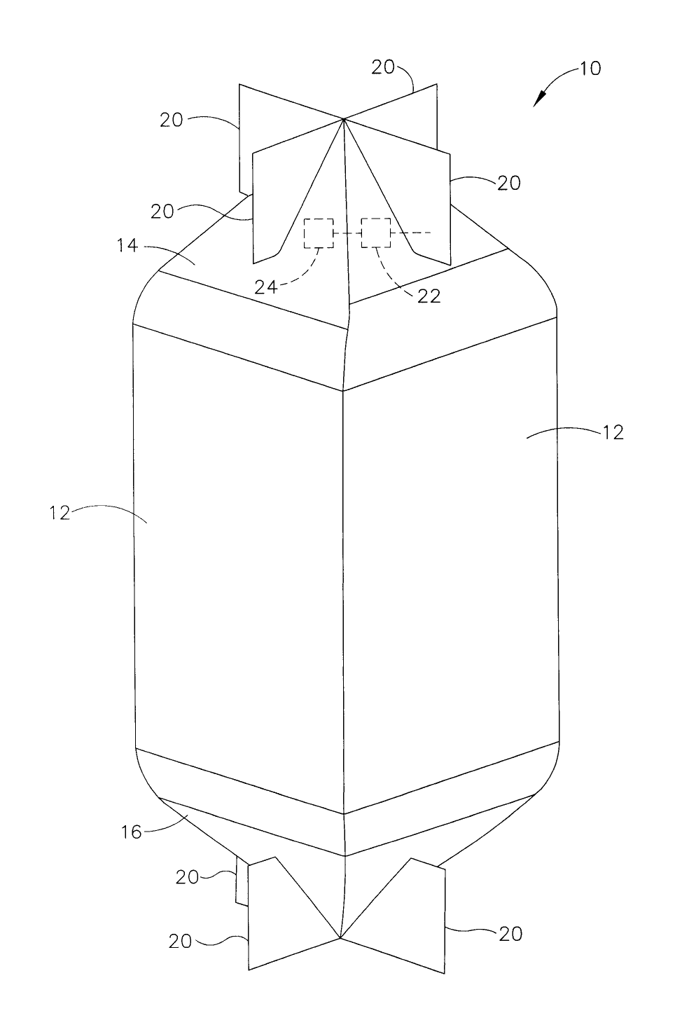

FIG. 1 shows an embodiment of elevator car 10 configured in accordance with the teachings of the present invention. Elevator car 10 may include four side walls 12. At least one side wall 12 includes an entryway and one or more sliding doors. Elevator car 10 travels within a hoistway and may be driven by any suitable hoisting system known in the art. For example, the hoisting system may be a traction system, a hydraulic system, or the like. In addition, elevator car 10 may include one or more guiding members, each of which slidably engage a corresponding vertically extending guide rail within the hoistway.

Elevator car 10 may include an aerodynamic surface disposed at either end of elevator car 10 configured in any suitable configuration, such as upper dome 14 secured atop the roof of the elevator car 10, and lower dome 16 secured at the lower end elevator car 10. In the embodiment depicted, each dome 14, 16 is generally pyramid shaped, however, it should be appreciated that domes 14, 16 may be any suitable aerodynamic shape and size favorable to one, or both, directions of travel of elevator car 10.

One or more moveable aerodynamic control surfaces 20, such as fins, are movably secured to elevator car 10, such as to each dome 14, 16. As the speed of elevator car 10 increases, aerodynamic control surfaces 20 may be moved to generate counter forces to the aerodynamic forces resulting from airflow around elevator car 10 and/or the mechanical forces resulting from the interaction between the guiding members and guide rails. Aerodynamic control surfaces 20 may be attached in any suitable manner to provide the desired movement to enable aerodynamic control surfaces 20 to counter the aerodynamic forces, and may be attached to the car structure directly, to domes 14, 16 or any suitable structure or component of elevator car 10 suitable to carry aerodynamic control surfaces 20. Aerodynamic control surfaces 20 may be of any suitable size, shape and number, configured to move in at least one suitable direction, and may be provided with multiple axes of movement and directions of translation as suitable. Aerodynamic control surfaces 20 may be of any suitable material. Aerodynamic surfaces at one or more end of elevator car 10, domes 14, 16 in the embodiment depicted, may be omitted and only aerodynamic control surfaces 20 incorporated in elevator car 10, although it is anticipated that performance of aerodynamic control surfaces 20 is better with the presence of aerodynamic surfaces at one or more end of elevator car 10, such as domes 14, 16.

Aerodynamic control surfaces 20 may be moved by one or more suitably configured actuator 22, such as an electric servo motor or a hydraulic servo motor. Such one or more actuators 22, diagrammatically illustrated, may be attached in any suitable manner, such as to the car structure directly or any suitable structure or component of elevator car 10, and connected to aerodynamic control surfaces 20 in any manner suitable to effect movement of aerodynamic control surfaces 20, such as through a connecting member or rod (not visible in FIG. 1) disposed between an actuator and an aerodynamic control surface 20. Domes 14, 16, may be configured to accommodate any such connecting members as may be necessary based on the location of the one or more actuators relative to aerodynamic control surfaces 20.

Aerodynamic control surfaces 20 are controlled by at least one aerodynamic control 24, diagrammatically illustrated, which functions in the same manner as a control for active roller guides. Aerodynamic control 24 may be configured to provide a control signal, which is received by at least one actuator 22, to move aerodynamic control surface 20 associated with the at least one actuator 22 so as to cause the aerodynamic control surface 20 to generate counter forces to the aerodynamic forces resulting from airflow around elevator car. Elevator car 10 may be provided with sensors, such as accelerometers or inertia sensors, to detect accelerations of elevator car 10 and its frame. An example of the processing of the output of such sensors is to integrate the output to create a velocity signal indicative of vibrations of elevator car 10. The velocity signal may be amplified and used to power an electrical actuator to create an opposing force so that the velocity detected by the sensor may be reduced to or toward zero.

Elevator car 10 may be provided with sensors to detect displacements of elevator car 10 relative to the guide rails. In response, at least in part, to signals indicative of such displacements of elevator car 10, aerodynamic control surfaces 20 may be actuated to move elevator car 10 to or toward its original position prior to being disturbed.

While the present invention has been illustrated by the description of several embodiments and while the illustrative embodiments have been described in considerable detail, it is not the intention of the applicant to restrict or in any way limit the scope of the appended claims to such detail. Additional advantages and modifications may readily appear to those skilled in the art.

1. An aerodynamic control system for an elevator car, said system comprising at least one moveable aerodynamic control surface configured to be carried by said elevator car which is moved to generate counter forces to aerodynamic forces resulting from airflow around said elevator car.

2. An elevator car comprising:
(a) at least one moveable aerodynamic control surface carried by said elevator car;
(b) a control configured to control movement of said at least one aerodynamic control surface so as to generate counter forces to aerodynamic forces resulting from airflow around said elevator car.

3. The elevator car of claim 2, wherein said control is configured to generate a control signal, and comprising at least one actuator configured to receive said control signal, said at least one actuator operably connected to said at least one aerodynamic control surface and configured to effect movement of said aerodynamic control surface in response said control signal.

4. The elevator car of claim 3, comprising at least one sensor configured to generate a sensor signal, said control configured to receive said sensor signal and generate said control signal based on said sensor signal.

5. The elevator car of claim 4, wherein said sensor is configured to sense acceleration of said elevator car.

6. The elevator car of claim 4, wherein said sensor is configured to sense displacement of said elevator car.

7. A method of countering aerodynamic forces resulting from airflow around an elevator car, said method comprising the steps of moving an aerodynamic control surface in response to acceleration of said elevator.
